(19) United States
(12) Patent Application Publication
(10) Pub. No.: US 2019/0096277 A1
(43) Pub. Date: Mar. 28, 2019

(54) SYSTEMS AND METHODS FOR MEASURING READING PERFORMANCE

(71) Applicants: Peter J. Bex, (US); Ohio State Innovation Foundation, Columbus, OH (US); Adaptive Sensory Technology, Inc., San Diego, CA (US)

(72) Inventors: Zhong-Lin Lu, Dublin, OH (US); Fang Hou, Zhejiang (CN); Deyue Yu, Columbus, OH (US); Peter J. Bex, Concord, MA (US); Luis A. Lesmes, San Diego, CA (US)

(73) Assignees: Ohio State Innovation Foundation, Columbus, OH (US); Adaptive Sensory Technology, Inc., San Diego, CA (US)

(21) Appl. No.: 16/140,981

(22) Filed: Sep. 25, 2018

Related U.S. Application Data
(60) Provisional application No. 62/562,810, filed on Sep. 25, 2017.

(51) Int. Cl. G09B 17/00

(52) U.S. Cl. CPC G09B 17/00

(57) ABSTRACT

The present disclosure relates to systems and methods for measuring reading performance.

### CROSS-REFERENCE TO RELATED APPLICATION

This application claims the benefit of U.S. Provisional Patent Application No. 62/562,810, filed on Sep. 25, 2017, entitled “SYSTEMS AND METHODS FOR MEASURING READING PERFORMANCE”, the contents of which are incorporated herein by reference.

### GOVERNMENT SPONSORSHIP

This invention was made with government support under EY021553 and EY025658 from the National Eye Institute. The government has certain rights in the invention.

### TECHNICAL FIELD

This disclosure generally relates to systems and methods for measuring reading performance.

### BACKGROUND

Reading is an important visual task that includes use of a number of different sensory, motor, and cognitive functions. A deficit or a pathology in at least one of these functions can impair reading performance. For example, an individual's reading performance can be impaired by deficiencies in the individual's sensory function. A broad range of ophthalmic and optometric disorders can affect sensory function and impair reading performance by reducing an individual's visual acuity and contrast sensitivity function (CSF). Visual acuity defines the smallest object a person can see. The contrast sensitivity function describes the amount of contrast that is required for a person to see spatial patterns with different sizes or spatial frequencies. Disorders that affect visual acuity and/or contrast sensitivity can include, but are not limited to, refractive error, cataract, age-related macular degeneration (AMD), retinitis pigmentosa, diabetic retinopathy, amblyopia and glaucoma.

Reading performance can also be impaired by a broad range of oculo-motor disorders by reducing control of eye movements and fixations. Disorders that can affect oculo-motor control can include vergence insufficiency, strabismus, traumatic brain injury, concussion and nystagmus. In an even further example, reading performance can be impaired by a broad range of cognitive disorders by impacting executive function, memory, attention and comprehension of the individual. Disorders that can affect cognitive function can include, but are not limited to, dyslexia, attention deficit, hyperactivity disorder, autism, stroke, Alzheimer's disease, concussion and traumatic brain injury. As such, reading performance can reflect the states of sensory, motor and cognitive functions of the individual.

Reading tests can be used to measure an individual's reading performance. A reading test may include use of at least an MNREAD chart, an SKREAD chart, a Radner reading chart, a Pepper test, and/or a Jaeger reading chart. Alternatively, reading performance may be measured using computerized tests, in which graphical standardized matter is presented on a display to the individual. Reading tests can be used to provide an estimate of a rate at which standardized matter (e.g., written, printed, graphical, computer displayed or a combination thereof) can be read accurately at a range of font sizes, font style, background luminance, contrasts, and/or letter, word or line spacing.

### SUMMARY

In an example, a computer implemented method can include generating a reading performance model that can include a set of reading parameters based on baseline reading performance data and baseline oculomotor control data. The reading performance model can provide an estimated reading performance for an individual. The computer implemented method can further include determining one or more stimulus parameters for the reading test including, but not limited to font size, display duration, and retinal location, based on the set of reading parameters, and controlling an administration of the reading test to the individual based on the one or more stimulus parameters. The reading test can be administered to the individual to assess the individual's reading performance. The computer implemented method can further include receiving reading performance data characterizing one or more responses the individual made in the reading test, and eye movement data characterizing eye movements made by the individual during the reading test, and updating the set of reading parameters of the reading performance model based on the reading performance data and the eye movement data to estimate the reading performance for the individual. The generating, the controlling, the receiving and the updating can be repeated according to a criterion to refine the estimated reading performance for the individual for a plurality of subsequent administrations of the reading test.

In another example, a system can include a non-transitory memory to store machine readable instructions and data. The system can further include a processor to access the memory and execute the machine readable instructions. The machine readable instructions can cause the processor to define a reading performance model comprising a set of reading parameters based on the baseline reading performance data and baseline eye movement data. The reading performance model can provide an estimated reading performance for an individual. The machine readable instructions can further cause the processor to determine stimulus parameters for a reading test based on the set of reading parameters, and control an administration of the reading test to the individual based on the stimulus parameters. The reading test can be administered to the individual to assess the individual's reading performance. The machine readable instructions can further cause the processor to receive reading performance data characterizing one or more responses the individual made in the reading test and eye movement data characterizing eye movements made by the individual during the reading test, and update the set of reading parameters of the reading performance model based on the reading performance data and the eye movement data to estimate the reading performance for the individual.

In an even further example, a computer implemented method can include defining a reading performance model comprising a set of reading parameters based on baseline reading performance data and baseline eye movement data. The reading performance model can provide an estimated reading performance for an individual. The computer implemented method can further include receiving performance data characterizing one or more responses of the individual in a plurality of reading test administered to the individual and eye movement data characterizing eye movements made by the individual based on a plurality of administered reading test to the individual, and updating the set of reading parameters of the reading performance model based on the reading performance data and the eye movement data to estimate the reading performance for the individual.

This Summary is provided merely for purposes of summarizing some example embodiments to provide a basic understanding of some aspects of the disclosure. Accordingly, it will be appreciated that the above described example embodiments are merely examples and should not be construed to narrow the scope or spirit of the disclosure in any way. Other embodiments, aspects, and advantages of various disclosed embodiments will become apparent from the following detailed description taken in conjunction with the accompanying drawings which illustrate, by way of example, the principles of the described embodiments.

### BRIEF DESCRIPTION OF THE DRAWINGS

Features, objects and advantages other than those set forth above will become more readily apparent when consideration is given to the detailed description below. Such detailed description makes reference to the following drawings.

FIG. 1 illustrates an example of a reading test system for measuring reading performance.

FIG. 2 illustrates an example of a flow diagram illustrating an exemplary method for measuring reading performance.

FIG. 3 schematically illustrates an exemplary computing environment in which systems and methods described herein can be implemented.

FIG. 4 illustrates an exemplary reading function characterizing read speed versus print size.

FIGS. 5(a)-5(f) illustrate reading performance measurements for a simulated individual.

FIGS. 6(a)-(d) illustrate, respectively, an inter-run standard deviation and an intra-run half width of 68.2% credible interval (HWCI) of parameters α, κ and η, and estimated reading speeds.

FIG. 7 illustrates a display sequence in one trial of an actual reading measurement test.

FIG. 8 illustrates reading functions provided based on the techniques described herein and a Psi method for each individual.

FIGS. 9(a)-9(d) illustrates parameters of a reading speed versus print size function α, κ and η, and estimated reading speeds.

FIG. 10(a) illustrates an inter-run standard deviation and an intra-run HWCI of an estimated reading speed as a function of test number.

FIG. 10(b) illustrates an average absolute bias (AAB) of an estimated reading speed as a function of test number.

FIG. 11 illustrates results of a model fit for all individuals.

### DETAILED DESCRIPTION

Clinicians utilize reading performance measurements for clinical and/or developmental assessment. To provide effective, precise and accurate assessments for an individual, reading performance measuring conditions (e.g., conditions for administering reading performance tests) must be controlled and regulated. As such, clinicians dedicate a substantial amount of their time in preparing for and administering reading tests to ensure that their tests are not contaminated with biases and large variabilities (e.g., clinician and individual induced testing errors). For examples, to obtain a reading speed versus print size function, clinicians usually need to measure reading speeds at eight to ten print sizes, taking 5-15 minutes in chart-based tests and an upper bound of 5 minutes per print size in a more precise test.

Although clinicians try to safeguard their tests against biasing such errors are introduced into tests used to measure reading performance. In some instances, the clinician is not aware that a bias has been introduced into the reading test. Consequently, given that existing reading procedures are contaminated with biases and variabilities from the clinician and/or individual, it prohibits the clinician from accurately and precisely assessing the individual reading performance. Potential sources of error, for example, can include the use of a manual timer to determine the start and end times for the reading test and detection of mispronunciations. Eye movements and fixation patterns are generally not measured quantitatively during reading tests, but may be informally observed by the clinician. Eye movement behavior is not recorded such that unbiased and precise information is not captured by the test. Even further, existing reading testing procedures, do not collect eye movement data, which could be analyzed to improve the quality and accuracy of the reading performance measurement.

Moreover, existing reading testing procedures often require reading aloud that may be both physically and emotionally uncomfortable for the individual. As a consequence, the individual can struggle to stay focused and keep still for the reading test, which results in biasing and variabilities and thereby undermining the clinician's ability to accurately and precisely measure the individual's reading performance. Computerized reading testing procedures although have eliminated the need for clinicians to manually record reading times, these tests still require that the clinician enter reading errors, which can be difficult to identify and characterize, and can only measure reading speed at one print size at a time, without considering any relationship between reading speeds at different print sizes. As such, existing reading testing procedures are time-consuming, fail to provide an accurate and precise measure of individual's reading performance, are able to only measure readings speeds at a particular print size at a time, and fail to consider relationships between reading speeds at different print sizes. As such, existing reading testing procedures (or tests) are prohibitive to clinical examination, diagnosis and/or therapy.

Systems and methods are described herein for measuring and estimating reading performance in a relatively short period of time, and in an accurate and precise manner. According to the systems and methods described herein, a reading test can be administered to the individual or self-administered in a relatively short period of time, and in an accurate and precise manner in contrast to available reading testing procedures. The systems and methods described herein can provide a reading performance measurement that is not contaminated with biasing errors from the individual and/or clinician during a reading test administration. In addition, in some examples, the systems and methods described herein can be used to measure reading speeds while considering relationship(s) between reading speeds at different print sizes. In some examples, eye movement data can be collected simultaneously during the reading test. In further examples, the systems and methods described herein can be used to measure an individual's peripheral vision reading performance. For peripheral vision assessment, the eye tracking data can be evaluated by the systems and methods described herein to provide accurate control of stimulus placement in the visual field.

Moreover, the systems and methods described herein can be used by clinicians to provide efficient, effective, and accurate clinical and developmental assessment. For example, clinicians can use the reading performance measurements determined according to the systems and methods described herein to evaluate effects that traumatic brain injury and/or other neurological disorders including concussion, stroke and Alzheimer's disease can have on the individual. Even further, the reading performance measurements determined according to the systems and methods described herein can be used to provide a degree of development, such as human development (e.g., child development and aging). Moreover, the reading performance measurements as determined herein can be used for pediatric functional assessment including dyslexia, learning disorders, attention deficit, hyperactivity disorder, and autism spectrum disorder. In some examples, the reading performance measurements as determined herein can be used for prescribing suitable adaptive devices (e.g., a handheld, head-mounted, desktop or portable electronic magnifier) for individuals that have low vision. In an even further example, the reading performance measurements as determined herein can be used to control one or more parameters of a therapy being delivered to an individual that may be pharmacological, surgical or behavioral for a related medical condition. The addition of eye tracking data can provide additional insight concerning oculomotor control during reading that can be diagnostic of the source of a reading impairment, and can be used to track progression or remediation of symptoms during treatment.

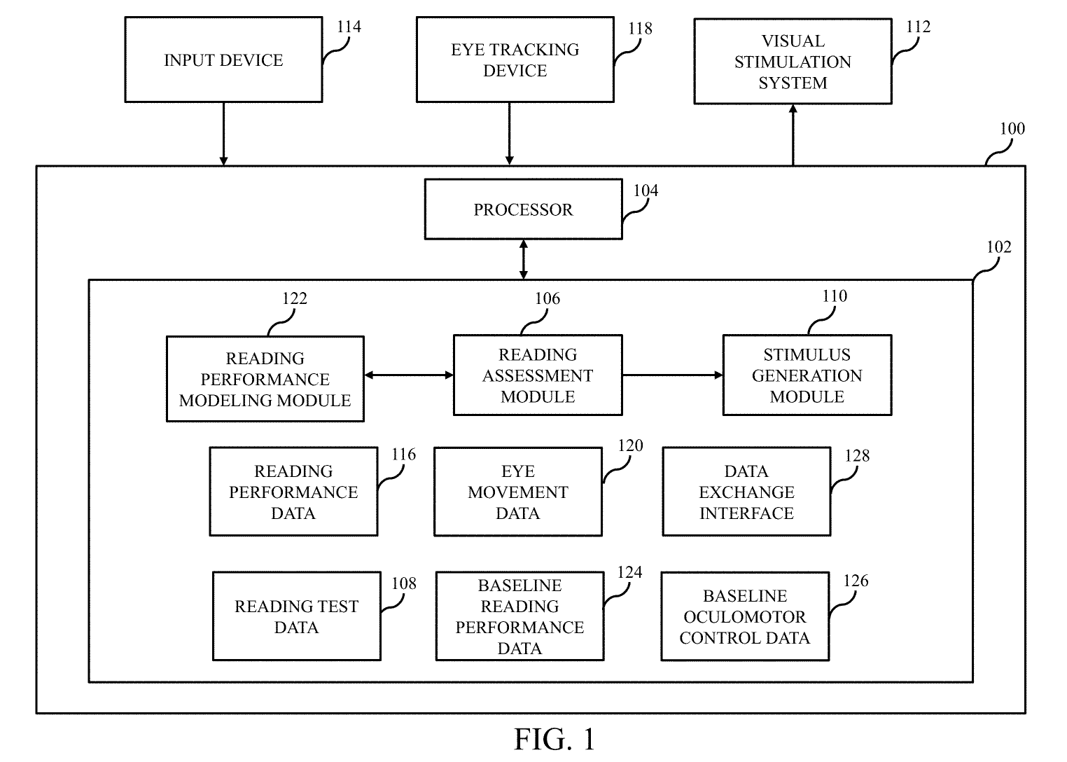

FIG. 1 illustrates an example of a reading test system (RTS) 100 that can be configured to assess reading performance. In some examples, the RTS 100 can be implemented on a computer, such as a laptop computer, a desktop computer, a server, a tablet computer, a workstation, a microcontroller unit, a field-programmable gate array (FPGA), multiple computers, or the like. The RTS 100 can include a memory 102 for storing data and machine-readable instructions. The memory 102 can be implemented, for example, as a non-transitory computer storage medium, such as volatile memory (e.g., random access memory), non-volatile memory (e.g., a hard disk drive, a solid-state drive, flash memory, or the like), or a combination thereof. The RTS 100 can include a processor 104 that can be configured to access the memory 102 and execute the machine-readable instructions stored in the memory 102. The processor 104 can be implemented, for example, as one or more processor cores. In the present example, although the components of the RTS 100 are illustrated as being implemented on the same system, in other examples, the different components could be distributed across different systems and communicate, for example, over a network, including a wireless, wired, or a combination thereof.

The memory 102 can include a reading assessment module 106. The reading assessment module 106 can be programmed to retrieve reading test data 108 stored in the memory 102 for a reading test. The reading test data 108 can characterize one or more reading test parameters for the reading test. In some examples, each of the reading test parameters can be user-definable (e.g., based on user input). As described herein, each of the reading test parameters can be continuously updated based on feedback data generated in response to user input during each administration of the reading test. The one or more reading test parameters can be updated for a future administration of the reading test based on user input from a prior administration of the reading test.

The one or more reading test parameters can include, but not limited to, a time duration for the reading matter being presented, a graphical element size, a type of graphical standardized matter, a Rapid Serial Visual Presentation (RSVP), a contrast graphical for the graphical standardized matter, a luminance, an orientation, a spatial frequency, a temporal frequency, a background, an illumination, an eccentricity, a font style for the graphical standardized matter, a color for the graphical standardized matter, or a combination thereof. The term “graphical standardized matter,” can refer to one or more graphical elements that can be rendered on a display and can be representative of a word, a sentence, an object, and a combination thereof. The RSVP parameter can define a rate (or duration) at which the graphical standardized matter should be presented on the display. The graphical element size parameter can define an overall bitmap font (e.g., a digital representation of a font) for the graphical standardized matter on the display. The contrast graphical parameter can define a lightness or darkness for the graphical standardized matter on the display based on an associated contrast value, which can be user definable. In some examples, the one or more reading test parameters can include a spacing parameter. The spacing parameter can define an amount of space between neighboring graphical elements on the display. In some examples, the one or more reading test parameters can include a viewing condition parameter. The viewing condition parameter can define a light level (e.g., a brightness, illumination and/or a glare) for a test environment in which the reading test is to be administered. The viewing condition parameter can also define an eccentricity or a retinal location at which the reading test is to be administered. Additionally, or alternatively, the viewing condition parameter can define a monocular or a binocular viewing condition for the individual during the reading test.

The memory 102 can include a stimulus generation module 110. The stimulus generation module 110 can be programmed to control a visual stimulation system 112. In some examples, the visual stimulation system 112 can include a display. The display can have a given refresh rate. In a non-limiting example, the given refresh rate can be a refresh rate in a range of 60 to 120 Hertz (Hz), or higher. In an example, the display can correspond to a ViewSonic® Graphic Series G220fb Cathode Ray Tube (CRT) monitor. The display can have a given pixel resolution. In a non-limiting example, the given pixel resolution can correspond to 1280×1024 pixel resolution.

In some examples, the reading assessment module 106 can be programmed to generate test display data based on the reading test data 108 for each administration of the reading test to the individual. The test display data can include, but not limited to, data characterizing a graphical standardized matter presented on a display (e.g., a test screen), luminance data, contrast data, size data, duration data, spacing data, content of the graphical matter data, or a combination thereof. The stimulus generation module 110 can be programmed to render a display screen (e.g., a reading test screen) on the display based on the test display data for each reading test administration. In some examples, the display screen can include the graphical standardized matter. In an example, the display can be configured to render the display screen in response to the reading assessment module 106 based on the one or more reading test parameters. Thus, the reading assessment module 106 can be programmed to control each reading test administration on an individual level via the visual stimulation system 112 based on the reading test data 108. Accordingly, each reading test can be administered to the individual in a computerized manner based on the one or more reading test parameters.

In some examples, during each reading test administration, the individual can provide one or more responses based on the stimulus/content on the display screen (e.g., the graphical standardized matter). The one or more responses can include information characterizing one or more graphical elements depicted on the display during a given reading test administration. For example, if the one or more graphical elements correspond to the word “car,” the one or more responses can include information representative of the word “car.” The individual can provide the one or more responses at an input device 114. The input device 114 can include an audio device, such as a microphone, or the like. Additionally, or alternatively, the input device 114 can include a keyboard, a mouse, a tracker-ball, or the like. In some examples, the input device 114 can be part of the RTS 100. The input device 114 can be configured to generate reading performance data 116 based on the one or responses from the user. The reading performance data 116 can correspond to the feedback data, as previously described herein. The processor 104 can be configured to receive the reading performance data 116 and store the reading performance data 116 in the memory 102.

In some examples, during the given reading test administration, an eye tracking device 118 can be configured to record an individual's eye movement. In some examples, the tracking device 118 can be part of the RTS 100. The eye tracking device 118 can be configured to obtain eye movement data 120. The eye movement data 118 can include data characterizing one of a fixation duration, a fixation stability, a saccade amplitude, a saccade direction, a number of saccades, a saccade accuracy of the eye movement control from the individual during the given reading test administration, and a combination thereof. As such, the eye movement data 120 can contain rich information about reading behavior, including, but not limited to, the duration of the subject fixation on each letter and/or word, a distribution area of gaze positions during each fixation, how many letter/words the subject skips between fixations, how frequently the subject re-fixates a previously-viewed word, how accurate is each saccadic eye movement to the next word, or a combination thereof. As described herein, the eye movement data 118 can be used to update a reading performance model. The processor 102 can be configured to store the eye movement data 118 in the memory 102.

In some examples, the eye tracking device 118 can include one of an infra-red based eye tracking camera, a web camera, an external camera, and the like. As such, in some examples, the eye tracking device 118 can be configured to obtain oculomotor control data to characterize a subject's oculomotor performance relative to age-matched normative control data (e.g., the parameters of the subject's fixation and saccadic eye movements). In an example, the oculomotor control data can be used to adjust stimulus parameters based on the subject's eye movements, in a gaze-contingent display, so that the position or timing of text presentation on the display may be adjusted based on the subjects ongoing gaze position. In some examples, the oculomotor control data can correspond to the eye movement data 120. In other examples, the oculomotor control data can form part of the eye movement data 120.

The reading assessment module 106 can be programmed to receive (or retrieve) the reading performance data 116 and/or the eye movement data 120 stored in the memory 102. The reading assessment module 106 can be programmed to update the one or more reading test parameters associated for a subsequent reading test administration. For example, the reading assessment module 106 can be programmed to update the one or more reading test parameters for each subsequent reading test administration based on the reading performance data 116 and/or the eye movement data 120 associated with a prior reading test administration. Accordingly, the reading assessment module 106 can be programmed to dynamically update the one or more reading parameters for each subsequent reading test administration. By dynamically updating the one or more reading parameters based on the prior reading test administration, subsequent reading test administrations can be adjusted (or modified) to improve an accuracy at which the reading performance of the individual is being assessed. As such, the amount of time required to assess the individual's reading performance is less than an amount of time required for currently available existing techniques for measuring reading performance.

The RTS 100 can include a reading performance modeling module 122. The reading performance modeling module 122 can be programmed to be in communication with the reading assessment module 106. The reading performance modeling module 122 can be programmed to generate a reading performance model, for example, in response to the reading performance assessment module 106. The reading performance model can be one of a parametric model (e.g., exponential, parabolic, two lines, Gaussian, polynomial, or the like), a non-parametric model, and a combination thereof. The reading performance modeling module 122 can be programmed to retrieve (or receive) baseline reading performance data 124 and baseline oculomotor control data 126 stored in the memory 102. Although the baseline reading performance data 124 and baseline oculomotor control data 126 is shown in FIG. 1 as being stored locally, in some examples, the baseline reading performance data 124 can be retrieved from and/or provided by an external device via a data exchange interface 128.

In some examples, the RTS 100 can include the data exchange interface 128. The data exchange interface 128 can be programmed to send and/or receive one of the reading test data 108, the reading performance data 116, the eye movement data 118, the baseline reading performance data 126, the baseline oculomotor control data 126, and a combination thereof. In an example, the data exchange interface 128 can correspond to a graphic user interface for a user to input data and/or parameters. In some examples, the data exchange interface 128 can be a USB port, a serial port, or a network interface. For example, the RTS 100 can be configured to send the reading performance data 116 and/or the eye movement data 120 to a printer (not shown in FIG. 1) via the data exchange interface 128. In some examples, the reading assessment module 106 can be programmed to provide the reading performance data 116 generated according to the systems and methods described herein can be used to provide an outcome measure in clinical trials for assessing an effectiveness of treatments, surgical procedures, and rehabilitation techniques.

The reading performance modeling module 120 can be programmed to generate the baseline reading performance model based on baseline reading performance data 124 and/or baseline oculomotor control data 126. The baseline reading performance data 124 can characterize prior measured reading performances associated with a set of individual(s) determined to have a healthy reading performance. In an example, the baseline reading performance model can characterize an initial estimate of the set of individuals (or individual) reading speed (e.g., in words-per-minute (wpm)) over a range of letter sizes on a display. A healthy individual can correspond to a human that does not have a deficit or a pathology in one or more of motor, sensory and cognitive functions associated with reading performance. The baseline reading performance model can be used to provide an initial estimate of the individual's reading performance. The baseline oculomotor control data 126 can characterize oculomotor functions associated with a set of individual(s). As described herein, the baseline reading performance model can be dynamically updated based on the reading performance data 116 and/or the baseline oculomotor control data 126 for each reading test administration to provide a more accurate reading performance model for the individual. Thus, the estimates for the individual's reading speed relative to the range of letter sizes can be dynamically updated to provide a more accurate assessment of the individual's reading performance.

In some examples, the baseline reading performance model can include a reading function that can include a set of reading parameters. The reading function can provide an estimate of the individual's reading speed over the range of letter sizes. In an example, the reading function can correspond to an exponential function:

$$log 10 ( speed ( size ) ) = log 10 ( \frac{60}{τ ( size )} ) = log 10 ( α ) - ( log 10 ( α ) - log 10 ( {α}_{c} ) ) exp ( - \frac{( log 10 ( size ) - log 10 ( κ ) )}{η} ) , \qquad ( 1 )$$

wherein speed(size) is in wpm, θ=(α, κ, η) can be the set of reading parameters, a is an asymptotic reading speed in very large print sizes, corresponding to a maximum reading speed, κ is a print size at which a reading speed is at a α_{c} words per minute (wpm) (e.g., 360 wpm), τ is a slope of the reading function, and η is an ascending rate of the exponential function.

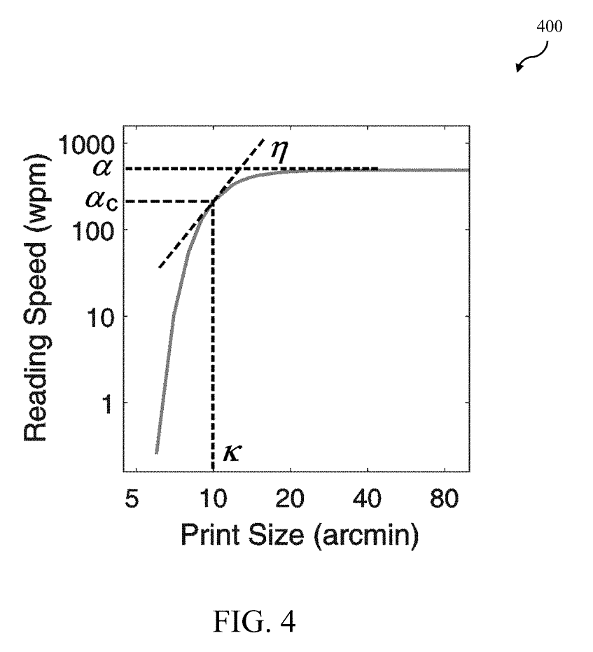

In some examples, the reading function (e.g., a reading speed versus print size function) can be characterized by three parameters: α, κ and, as illustrated by an exemplary reading function 400 in FIG. 4. Reading speed at a given print size can be defined by the threshold exposure duration τ (size) (in seconds) with which the individual performs the lexical decision task at 80.3% correct in that print size:

speed(size)=60/τ(size). (2)

In some examples, the set of reading parameters can include one or more oculomotor reading parameters which can be updated based on the oculomotor control data (e.g., provided by the eye tracking device 118). The one or more oculomotor reading parameters can include, in some examples, fixation time on the whole or each part of the reading materials, the accuracy and distance between successive saccades and the number of regressive fixations, and a combination thereof. In some examples, the oculomotor control data can quantify an amplitude and accuracy of saccadic eye movements between reading words, and/or a location and area of fixational eye movements during reading of graphical standardized matter on the display (e.g., a word) during a reading test administration. The one or more oculomotor reading parameters can provide an estimate of the individual's oculomotor control over the range of letter sizes, contrasts, luminances, colors, font types, letter spacings, line spacings, and/or illumination conditions.

In some examples, the individual's eye movement patterns can be used to determine reading performance on a word-by-word basis as the individual reads the text, rather than a global estimate based on the overall time or accuracy of reading a passage of text. In some examples, the oculomotor control data can characterize the timing and accuracy of sub-components of reading, including the duration the subject fixates on each letter or word, the distribution area of gaze positions during each fixation, how many letter/words the subject skips between fixations, how frequently the subject re-fixates a previously-viewed word, and how accurate is each saccadic eye movement to the next word. The reading performance model can include other measures in addition to reading accuracy. As such, the reading model can be characterized at higher resolutions than only a single estimate of reading speed and/or accuracy.

The reading assessment module 106 can be programmed to update the set of reading parameters of the reading function based on the reading performance data 116 generated during each reading test administration. The reading assessment module can be programmed to refine the reading functions during each reading test administration by updating the set of reading parameters to provide a more accurate estimate of the individual's reading performance (e.g., reading speed over the range of letter sizes). As such, a more refined reading function can be generated by the RTS 100 to provide a clinician a more accurate reading performance assessment for the individual. In an example, the reading assessment module 106 can be programmed to update the set of reading parameters of the reading function based on the reading performance data 116 according to a Bayesian inference. For example, the reading assessment module 106 can be programmed to generate a prior probability distribution for each reading parameter of the set of reading parameters. The reading assessment module 106 can be programmed to update the probability distribution for each of the reading parameters based on the reading performance data 116 generated during each reading test administration.

The reading assessment module 106 can be programmed to characterize each reading parameter by a probability density function, p₀(θ), to represent a relative likelihood that a value of a given reading parameter would equal that sample. In an example, each of the probability density functions, p₀(θ), can be one of a uniform density function, a hyperbolic probability density function, and a combination thereof. Additionally, or alternatively, the reading assessment module 106 can be programmed to characterize each reading parameter by a three-dimensional joint probability distribution in a parameter space. The reading assessment module 106 can be programmed to define a broad joint prior distribution p₀(θ) in a three-dimensional parameter space θ=(α, κ, η). The parameter space can represent all possible variations of the reading function.

The reading assessment module 106 can be programmed to, after each reading test administration, update the prior distribution for each reading parameter to a posterior distribution based on the reading performance data 116 generated during a prior reading test administration (e.g., by the individual) according to a Bayes' rule:

$${p}_{t} ( θ ) = {p}_{t} ( θ \vert {r}_{x} ) = \frac{{p}_{t - 1} ( θ ) p ( {r}_{x} \vert θ )}{{\sum }_{θ} {p}_{t - 1} ( θ ) p ( {r}_{x} \vert θ )} , \qquad ( 3 )$$

wherein θ represents parameters of the reading function, pₜ₋₁(θ) is the prior probability density function of θ of a previous administration of the reading test, p(rₓ|θ) is a likelihood of observing a response (e.g., correct or incorrect) given θ and a given stimulus parameter x, rₓ, is the individual's response in a subsequent administration of the reading test according to the given stimulus parameter x and pₜ(θ|rₓ) is the posterior distribution of θ after the subsequent reading test administration. Thus, a given individual's response rₓ to the given stimulus parameter x presented at a t^{th} test (e.g., trial), the prior distribution pₜ₋₁(θ) can be updated to the posterior distribution pₜ(θ|rₓ) according to the Bayes' rule. Accordingly, the individual's response provided in the t^{th} administration can be used to update the prior knowledge about parameter pₜ₋₁(θ) according to the Bayes' rule.

The posterior distribution of t^{th} administration can be used as the prior of t+1^{th} administration:

pₜ₊₁(θ)=pₜ(θ|rₜ, x). (4)

Marginal posterior distributions of the reading parameters can be computed via a summation:

pₜ(α|rₜ, x)=Σ_{κ}Σ_{τ}pₜ(θ|rₜ, x), (5)

pₜ(κ|rₜ, x)=Σ_{α}Σ_{τ}pₜ(θ|rₜ, x), (6)

pₜ(η, rₜ, x)=Σ_{α}Σ_{κ}pₜ(θ|rₜ, x). (7)

The expected mean of the marginal posterior distributions can be estimates of the set of reading parameters after t^{th} administration:

[symbol]

=Σθᵢ·pₜ(θᵢ|rₜ, x), (8)

where θᵢ=α, κ, or η, for i=1, 2 and 3.

To generate an observer model pₜ(rₜ|θ, x), a likelihood of observing a correct and incorrect response given θ (e.g., for a given word/non-word lexical decision task correctly in a given print size and exposure duration condition)), a probability correct p(r=1) psychometric function can be approximated by the following psychometric Weibull function:

$$p ( r = correct \vert θ ) = Ψ ( duration ( size ) ) = γ λ + ( 1 - λ ) ( γ + ( 1 - γ ) ( 1 - exp ( - {( \frac{duration}{τ ( size )} )}^{β} ) ) ) , \qquad ( 9 )$$

wherein γ is a guessing rate (e.g., 0.5) of a given m-alternative-forced-choice (m-AFC) task (e.g., a word/nonword lexical decision task), β is a slope of the psychometric function (e.g., in some examples can be set to 2.0 based on baseline data collected for individuals), γ is a lapse rate for the task (e.g., 0.4), τ(size) is a threshold exposure duration (e.g., corresponding to 80.3% correct in a print size condition), and the duration is an amount of time for the graphical matter used in the test. According to equations 1, 2 and 9, the systems and methods described herein can model the response accuracy of the individual in any print size and exposure duration condition in a decision tasks (e.g., the lexical decision task).

Psychometric functions other than Weibull function (e.g., as shown in Equation 8), such as Gaussian, logistic, empirical paradigm dependent function can be used in generating the observer model. For example, psychometric functions having a steeper slope for an m-Alternative Forced Choice (mAFC) task with a large m can be employed to significantly improve the test efficiency.

The probability of an incorrect response (r=0) is:

p(r=incorrect|θ)=1−Ψ(x, θ). (10)

The reading assessment module 106 can be programmed to determine a stimulus parameter x for each reading test administration. The x can correspond to one or more reading test parameters. In an example, the stimulus parameter x can define the graphical element size (e.g., such as a font size for the graphical standardized matter on the display), a duration for displaying on the display the graphical standardized matter (e.g., the RSVP parameter), and a combination thereof. The stimulus parameter x can be used to regulate (or control) administration of the reading test to the individual by the visual stimulation system 112.

The stimulus parameter x determined for each administration of the reading test can correspond to the updated set of reading parameters. The reading assessment module 106 can be programmed to select an appropriate stimulus parameter x among a plurality of stimulus parameters x in joint stimulus space of graphical element size and duration X that can cover all possible graphical element sizes and durations, x∈X that can optimize an expected information gain about the set of reading parameters of the reading function. It can also include other test conditions such as retinal location. In an example, the reading assessment module 106 can be programmed to perform a one-step ahead search for minimum entropy based on the plurality of stimulus parameters x in the two-dimensional stimulus graphical element size and duration space X. As such, in some examples, the stimulus space can contain all possible print sizes and presentation durations to be test during a test x=(size, duration).

To determine a given stimulus parameter x for a t^{th} administration of the reading test, the reading assessment module 106 can be programmed to predict an individual's response to every possible stimulus parameter x in the t^{th} reading test administration based on current estimated posterior probability density functions of the set of reading parameters. The reading assessment 106 can be programmed to compute the expected posterior distribution for the set of reading parameters for each possible stimulus parameter x. The reading assessment module 106 can be programmed to identify the given stimulus parameter x from the parameter space having one of the least expected entropy among the plurality of stimulus parameters x for the t^{th} reading test administration. This can be equivalent to optimizing the expected information gain, quantified as the entropy change between the prior and the posterior. In an example, the stimulus parameter x to be utilized in the next reading test can be randomly identified among the plurality of stimulus parameters x, for example with a top 10% of an expected information gain. The expected information gain of the stimulus parameter x can be defined as lₜ(θ; r):

lₜ(θ; r)=h(∫pₜ(θ)Ψ(x, θ)dθ)−∫pₜ(θ)h(Ψ(x, θ)) dθ, (11)

wherein h(p)=−plog(p)−(1 −p)log(1−p) is the information entropy of the distribution p.

Before the t^{th} administration, the reading assessment module 106 can be programmed to perform a one-step-ahead search to determine the stimulus xₜ condition (or parameter) to be used in the reading test administration, by optimizing the expected information gain over the entire stimuli space:

$${x}_{t} = {arg max}_{x} ( {I}_{t - 1} ( θ ; r ) ) \qquad ( 12 )$$

Accordingly, the reading assessment module 106 can be programmed to optimize the mutual information in each administration. Other information metrics, such as Fisher information or Kullback-Leibler information, can be used as utility functions for optimization in the reading assessment module 106. In an example, these information metrics/utility functions can be defined on the probability distribution of reading function parameters. In an alternative example, utility functions can be defined on the probability distribution of participant category, the probability distribution of raw (point-by-point) reading thresholds (e.g., threshold duration to achieve a certain reading accuracy at a given font size) can be used by the reading assessment module 106.

The reading assessment module 106 can be programmed to calculate the mutual information over an entire parameter space X for stimulus parameter x by a sampling method based on the probability distribution of the parameters. Such an approach substantially reduces the amount of time and computer resources (e.g., processing power, memory, etc.) that is need for assessing the individual's reading performance. Additionally or alternatively, the reading assessment module 106 can be programmed to calculate the mutual information over the entire parameter space X for stimulus parameter x by an exhaust search over the entire probability space, or utilize a Markov chain Monte Carlo (MCMC), particle filters, differential evolution Markov chain Monte Carlo (DE-MCMC), or other sampling technics and statistical tools to gain computational simplicity and/or testing efficiency.

In some examples, the reading assessment module 106 can be programmed to search for an optimal stimulus parameter x according to a one-step-ahead search. Alternatively, the reading assessment module 106 can be programmed to search for an optimal stimulus parameter x according to a multiple-step-ahead search. In another example, the reading assessment module 106 can be programmed to search for an optimal stimulus parameter x according to a global optimization (e.g., optimization based on available testing time or number of administrations) to gain additional efficiency, when applicable. As described herein, the reading assessment module 106 can be programmed to measure the reading speed as function of letter size. Moreover, the reading assessment module 106 can be programmed to measure the word presentation rate as function of other properties of the text, such as contrast, font style, color, luminance, spacing, orientation, spatial frequency, and eccentricity. The reading assessment module 106 can be programmed to incorporate a multidimensional (e.g., >two) stimulus space to measure reading performance as a function of multiple test display properties in a single reading test.

The reading assessment module 106 can be programmed to control the visual stimulation system 112 to administer the reading test to the individual based on the stimulus parameter x. For example, the reading assessment module 106 can be programmed to control the visual stimulation system 112 to expose the individual to the graphical standardized matter on the display based on the stimulus parameter x. The stimulus parameters x can correspond to a vector which can contain an array of elements xᵢ, i=1,2 3, . . . The graphical standardized matter on the display can have the given font size as defined by the x₁, and display duration as defined by the x₂. The reading assessment module 106 can be programmed to update the reading function over a plurality of reading tests according to a stopping criterion. In an example the stopping criterion is a given number of reading test administrations. In another example, the stopping criterion is a precision level for a defined objective. Thus, the criterion could be that the precision of estimates reaches a pre-determined level or an information gain in the reading test administration is smaller than a pre-defined level. Accordingly, by iteratively refining the probability density, p₀(θ), for each of the reading parameters based on the reading performance test data 116 during successive reading test administrations according to the Bayes' rule, reading performance for the individual can be precisely and efficiently assessed.

In some examples, the reading assessment module 106 can be programmed to store reading curve and eye movement data characterizing the reading curve and oculomotor function in the memory 102. The reading curve and eye movement data can be rendered on the display of the visual stimulation system 112 (or a different display), or sent to a printer through the data exchange interface 124 to provide a visual representation of the reading curve and oculomotor control function. A clinician can evaluate the visual representation to provide clinical and developmental assessment of the individual. For example, the clinical can evaluate the visual representation for therapy and/or diagnosis purposes.

Accordingly, the RTS 100 can be configured for a plurality of reading test administrations to update the probability density functions for each of the set of reading parameters of the reading function characterizing the individual's reading performance. The RTS 100 can be configured to update the set of reading parameters based on the reading performance data 116 during each reading test administration according to the Bayes' rule. The RTS 100 can be configured to continuously update the reading function after each reading test administration to provide a more accurate representation of reading performance for the individual in a substantially reduced amount of time when compared to existing reading performance technologies and/or techniques. By utilizing the RTS 100 for reading performance measurements effects of biasing (e.g., errors) from clinicians and/or individuals can be substantially reduced and thereby improving an accuracy and quality of the measured reading performance.

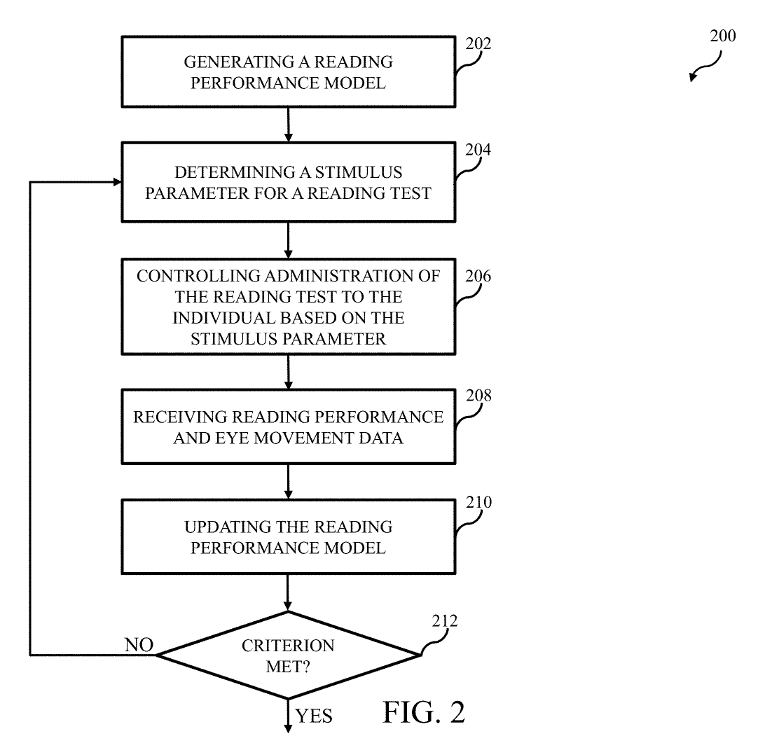

In view of the foregoing structural and functional features described above, a method that can be implemented will be better appreciated with reference to FIG. 2. While, for purposes of simplicity of explanation, the method of FIG. 2 is shown and described as executing serially, it is to be understood and appreciated that such method is not limited by the illustrated order, as some aspects could, in other examples, occur in different orders and/or concurrently with other aspects from that shown and described herein. Moreover, not all illustrated features may be required to implement the method. The method or portions thereof can be implemented as instructions stored in one or more non-transitory storage media as well as be executed by a processing resource (e.g., one or more processor cores) of a computer system, for example.

FIG. 2 depicts an example of a flow diagram illustrating an exemplary method 200 for assessing reading performance. In some examples, the method 200 can be implemented by a reading performance system such as the reading performance system, as illustrated in FIG. 1. The method can begin at 202 by generating a reading performance model that can include one or more reading parameters based on baseline reading performance data and baseline oculomotor control data. In some examples, the oculomotor control data can include data characterizing one of a fixation duration, a fixation stability, a fixation location within words or letters, a micro-saccade and saccade amplitude, a micro-saccade and saccade duration, a micro-saccade and saccade accuracy, saccade landing locations within words, saccade landing locations on successive lines, and combination thereof. The reading performance model can provide an initial estimate of an individual's reading performance. At 204, determining a stimulus parameter for a reading test based on the one or more reading performance parameters. The reading test can be administered to the individual to estimate the reading performance for the individual.

At 206, controlling an administration of the reading test to the individual based on the stimuli parameter. At 208, receiving reading performance data characterizing one or more responses of the individual in response to the reading test and eye movement data characterizing eye movements made by the individual during the reading test. At 210, updating the one or more behavior parameters based on the reading performance data and the eye movement data to provide an updated estimate of the individual's reading performance. At 212, updating the reading performance model characterizing the reading performance for the individual if the preset stopping criterion is not met (“NO”) by repeating 204, 206, 208, and 210 for a plurality of applications of the reading test. Alternatively, at 212, not updating the reading performance model if the preset stopping criterion is met (“YES”). Accordingly, the reading performance model can be iteratively updated after each reading test administration for the individual to provide a more accurate and precise estimate of the individual's reading performance.

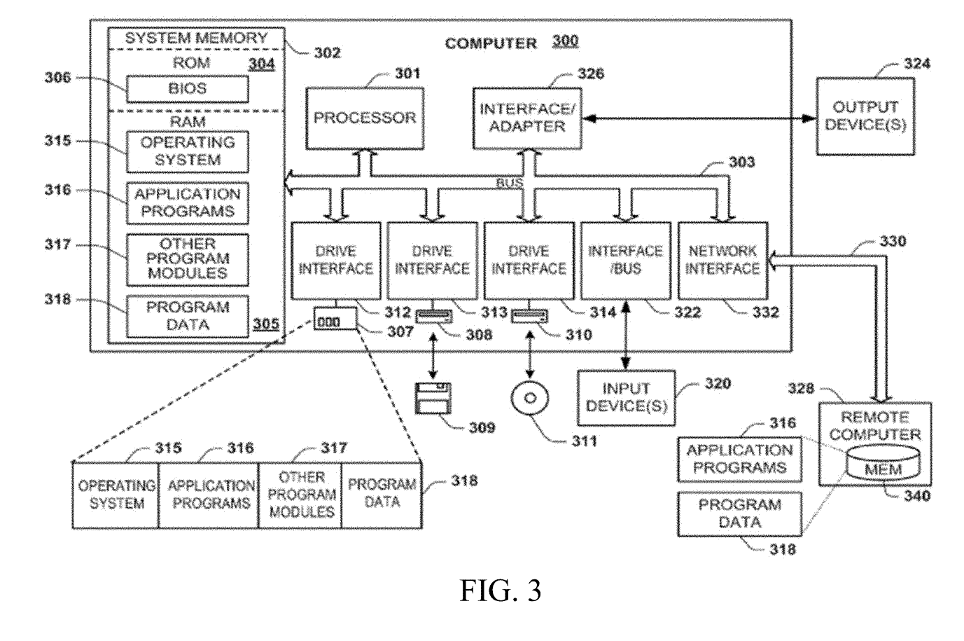

In view of the foregoing structural and functional description, those skilled in the art will appreciate that portions of the examples described herein may be embodied as a method, processing system, or computer program product. Accordingly, the examples described herein may take the form of an entirely hardware features, an entirely software features, or a combination of software and hardware, such as shown and described with respect to the computer system of FIG. 3. Furthermore, portions of the examples described herein may be a computer program product on a computer-usable storage medium having computer readable program code on the medium. Any suitable computer-readable medium can be utilized including, but not limited to, static and dynamic storage devices, hard disks, optical storage devices, and magnetic storage devices.

Moreover, certain examples described herein have also been referred herein with regards to block illustrations of methods, systems, and computer program products. It will be understood that blocks of the illustrations, and combinations of blocks in the illustrations, can be implemented by computer-executable instructions. These computer-executable instructions can be provided to one or more processors of a computer, or other programmable data processing apparatus (or a combination of devices and circuits) to produce a machine, such that the instructions, which execute via the one or more processors, implement the functions specified in the block or blocks.

These computer-executable instructions can also be stored in computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions can also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

In this regard, FIG. 3 illustrates an example of a computer system 300 that can be employed to execute one or more examples described herein, including, but not limited to, receiving (or retrieving) performance data, defining (or generating) models, updating models, determining one or more stimulus parameters, controlling a reading test, evaluating reading performance data, estimating an individual's reading performance, and controlling a therapy. Computer system 300 can be implemented on one or more general purpose networked computer systems, embedded computer systems, eye tracker systems, routers, switches, server devices, client devices, FPGA, various intermediate devices/nodes or standalone computer systems. Additionally, the computer system 300 can be implemented on various mobile clients such as, for example, a smart phone, a personal digital assistant (PDA), laptop computer, pager, and the like, provided it includes sufficient processing capabilities. In these examples, the computer system 300 can be programmed to communicate wirelessly with an eye tracking device (e.g., the eye tracking device 118, as illustrated in FIG. 1) and a visual stimulation system (e.g., the visual stimulation system 112, as illustrated in FIG. 1).

The computer system 300 can include processing unit 301, system memory 302, and system bus 303 that can couple various system components, including the system memory 302, to processing unit 301. The processing unit 301 includes, but not limited to, a central processing unit, and/or micro-controller unit. The process unit 301 can include dual microprocessors and other multi-processor architectures, or single or multi-core processing units. System bus 303 may be any of several types of bus structure including a memory bus or memory controller, a peripheral bus, and a local bus using any of a variety of bus architectures. System memory 302 can include read only memory (ROM) 304 and random-access memory (RAM) 305. A basic input/output system (BIOS) or Unified Extended Firmware Interface (UEFI) on a newer system 306 can reside in ROM 304 containing the basic routines that help to transfer information among elements within computer system 300.

The computer system 300 can further include a hard disk drive 307, magnetic disk drive 308, e.g., to read from or write to removable disk 309, and an optical disk drive 310, e.g., for reading CD-ROM disk 311 or to read from or write to other optical media. Hard disk drive 307, magnetic disk drive 308, and optical disk drive 310 can be connected to system bus 303 by a hard disk drive interface 312, a magnetic disk drive interface 313, and an optical drive interface 314, respectively. The drives and their associated computer-readable media provide nonvolatile storage of data, data structures, and computer-executable instructions for computer system 300. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of the disclosure described herein.

A number of program modules can be stored in drives and RAM 305, including operating system 315, one or more application programs 316, other program modules 317, and program data 318. The one or more program modules can include a reading assessment module (e.g., the reading assessment module 106, as illustrated in FIG. 1), a stimulus generation module (e.g., the stimulus generation module 110, as illustrated in FIG. 1), and a reading performance modeling module (e.g., the reading performance modeling module 122, as illustrated in FIG. 1). The application programs and program data can include functions and methods programmed to receive and process data to control an administration of reading tests to an individual. Moreover, the application programs and program data can include functions and methods programmed to estimate an individual's reading performance based on data generated during each administration of the reading test to the individual.

In some examples, a user can enter commands and information into computer system 300 through one or more input devices 320, such as a pointing device (e.g., a mouse, touch screen), keyboard, microphone, joystick, game pad, scanner, gaze position input, web camera, motion detector for gesture control and the like. In an example, the one or more input devices 320 can include the input device 114 as illustrated in FIG. 1. For instance, the user can employ input device 320 to control one or more features of the system described herein. These and other input devices 320 are often connected to processing unit 301 through a corresponding port interface 322 that is coupled to the system bus, but may be connected by other interfaces, such as a parallel port, serial port, or universal serial bus (USB). One or more output devices 324 (e.g., display, a monitor, printer, projector, or other type of displaying device) can also be connected to system bus 303 via interface 326, such as a video adapter.

Computer system 300 may operate in a networked environment using logical connections to one or more remote computers, such as remote computer 328. Remote computer 328 may be a workstation, computer system, router, peer device, or other common network node, and typically includes many or all the elements described relative to computer system 300. The logical connections, schematically indicated at 330, can include a local area network (LAN) and a wide area network (WAN). When used in a LAN networking environment, computer system 300 can be connected to the local network through a network interface or adapter 332. When used in a WAN networking environment, computer system 300 can include a modem, or can be connected to a communications server on the LAN. The modem, which may be internal or external, can be connected to system bus 303 via an appropriate port interface. In a networked environment, application programs 316 or program data 318 depicted relative to computer system 300, or portions thereof, may be stored in a remote memory storage device 340.

Accordingly, the systems and methods described herein can provide a measure of reading performance that is more accurate and precise than existing techniques, faster, and requires less clinician involvement. In some examples, the systems and methods described herein utilizes a Bayes rule and an information-theoretic framework to select the most informative stimulus each test and accumulate information about the reading speed versus print size function throughout the entire test procedure. As such, the systems and methods described herein have demonstrated great success in measuring a single sensory threshold and can achieve even higher efficiency when the systems and methods described herein are applied to measure more complex visual functions by exploiting functional regularities in human behavior.

In some examples, according to the systems and methods described herein, a word/non-word lexical decision task can be utilized to quantify a specific sub-task of reading and provide an assessment of reading abilities. Current reading tests require a clinician to judge reading accuracy and enter the number of reading mistakes. This renders them far less efficient than automated tasks that can be scored by a computer. However, automated computer scoring limits the specific reading tasks that can be implemented for reading testing. According to systems and methods described herein based on the word/non-word lexical decision task, a letter string can be briefly presented and followed by a mask, and an individual can be asked to report if the letter string is a word or a non-word. In some examples, the task can be considered as a special case (one-word version) of an RSVP reading task. The reading speed in words per minute can be computed as the reciprocal of threshold exposure duration (in seconds) times 60. The exposure duration and print size of the stimuli in the word/non-word lexical decision task can be manipulated according to the systems and methods described herein to focus on visual factors in reading while keeping language comprehension factors minimal.

In some examples, before each reading test administration, the systems and methods described herein can be configured to define a parameter space for all the possible reading functions θ=(α, κ, η) and a prior distribution of parameters p₀(θ) representing the clinicians' prior knowledge of the probability of different reading curves. During each reading test administration, the systems and methods described herein can search for the optimal print size and exposure duration in a stimulus space that can contain all possible print sizes and presentation durations via an information-theoretic approach, present the optimal stimulus to the individual, and collect the individual's response.

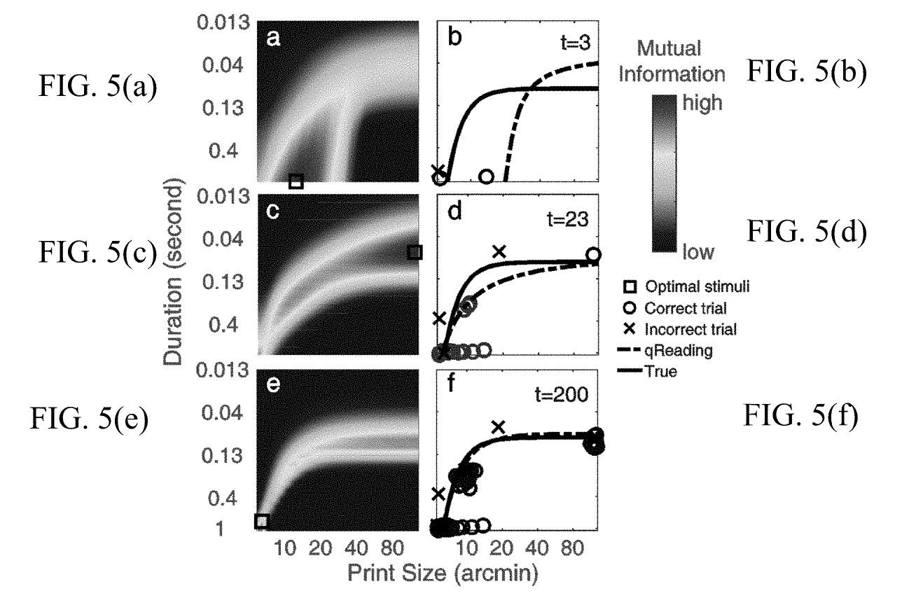

To evaluate a performance of the systems and methods described herein, the techniques described herein were applied to a simulated individual. FIGS. 5(a)-5(f) illustrate reading performance measurements for a simulated individual. In FIGS. 5(a)-5(f) dashes curves represent estimated reading speed versus print size according to the techniques described herein and continuous curves represent a true reading speed versus print size curves. In FIGS. 5(b), 5(d) and 5(f), crosses correspond to incorrect response and circles correspond to correct response. Locations of the crosses, circles and squares indicate stimulus conditions.

In FIGS. 5(a), 5(c) and 5(e), the mutual information of all potential stimuli in the stimulus space is shown at reading tests 3, 23 and 200. The location with the maximum mutual information, as indicated by a black square, represents the optimal stimulus used in a related reading test. The techniques described herein can be configured to accumulate information about the parameters α, κ and η by updating their joint posterior distribution based on the individual's response according to a Bayes' rule. The techniques described herein can be configured to obtain information about the entire reading function in each test instead of measuring reading speed at one print size at a time as existing techniques and therefore greatly improve test efficiency because the performance of the individual in any print size and duration condition is jointly determined by these parameters. As illustrated by FIGS. 5(b), 5(d) and 5(f), the estimated reading speed versus print size curve can be updated according to the responses made by individuals. As a number of reading test measurements increases, the estimated reading speed versus print size function approaches a true function.

During the simulation, a simulated individual performed a 2AFC word/non-word lexical decision task. The parameters of the simulated individual were: αₜᵣᵤₑ=1556 wpm, κₜᵣᵤₑ=9.26 arcmin, and ηₜᵣᵤₑ=0.129 log10 arcmin, based on the average parameter values obtained from a test experiment. The true reading speed versus print size function was then calculated based on equation 1, and used to generate the simulated individual's response probabilities based on equations 2 and 9. The techniques described herein where then utilized to estimate a reading function of the simulated individual based on the simulated individual's response during each test (e.g., simulated reading test administration).

For the simulation, the following parameter space was defined: 15 values evenly sampled from 2.55 to 3.75 (in log10 wpm units) for the asymptote α, 15 values evenly sampled from 0.46 to 1.66 (log10 arcmin units) for the critical size κ; and 15 values evenly sampled in log space from 0.079 to 1 (log10 arcmin units) for the ascending rate The prior of the parameters was defined as a uniform distribution in the corresponding region of the three-dimensional space. The range of possible stimuli was 60 print sizes from 5.79 to 129 arcmin and 20 durations from 0.013 to 1second. The stimulus space was then sampled evenly in log units in both dimensions.

During the simulation, the simulated individual was tested over 500 runs. Each run had 300 tests (e.g., simulated reading test administrations). In order to evaluate the performance of the systems and methods described herein, a precision and a bias of the estimated reading speed versus print size functions can be obtained. The precision of a method can be gauged by the variability of its estimates. A smaller variability means a higher precision. The inter-run standard deviation of the estimated parameters of the reading speed versus print size function can be computed according to:

$${SD}_{inter} = \sqrt{\frac{{\sum }_{j = 1}^{500} {( ( {log}_{10} ( {v}_{j} ) - {log}_{10} ( \overline{u} ) ) )}^{2}}{500}} , \qquad ( 13 )$$

wherein vⱼ is the estimated parameters α, κ or η, the j^{th} run, and v̅ is the mean of vⱼ over 500 runs. The inter-run standard deviation of the estimated reading speed was reading speeds over all 60 print sizes.

The precision with intra-run variability during the simulation, or the half width of the 68.2% credible interval (HWCI) of the posterior distribution of the parameters and the 68.2% HWCI of the distribution of the estimated reading speeds in a single run was examined. The latter was performed with a resampling procedure. 500 sets of parameters θ were sampled from the posterior distribution pₜ(74 ) from a single run with respect to techniques described herein. They were used to construct 500 reading functions and estimate the 68.2% HWCIs. The resampling procedure took into account of the covariance structure in the posterior distribution of the reading speed versus print size function parameters.

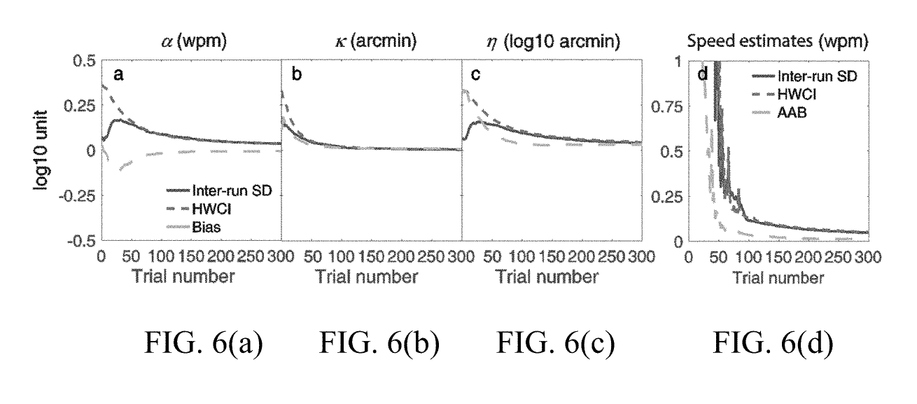

The inter-run standard deviation and intra-run HWCI of the parameters α, κ, η, as well as the estimated reading speeds according to the techniques described herein are plotted as functions of trial number in FIGS. 6(a)-6(d), respectively. Both inter-run standard deviation and intra-run HWCI decreased rapidly in about 50 trials. The inter-run standard deviation for estimated α, κ, η and reading speeds were 0.143, 0.044, 0.142 and 0.420 log10 units after 50 trials, respectively, and decreased to 0.065, 0.009, 0.068 and 0.084 log10 units after 150 trials, respectively. The intra-run HWCI for estimated α, κ, η and reading speeds were 0.161, 0.051, 0.177 and 0.723 log10 units after 50 trials, respectively, and decreased to 0.060, 0.011, 0.075 and 0.090 log10 units after 150 trials, respectively.

For the simulation, bias of the estimated parameters was computed according to:

$$Bias = \frac{{\sum }_{j = 1}^{500} ( {log}_{10} ( {v}_{j} ) - {log}_{10} ( {v}_{true} ) )}{500} , \qquad ( 14 )$$

wherein vⱼ is any one of the estimated parameters α, κ, η in the j^{th} run, and vₜᵣᵤₑ is the true value of the parameter.

The average absolute bias (AAB) of the estimated reading speeds was computed according to:

$$A A B = \frac{{\sum }_{k = 1}^{60} \vert {\sum }_{j = 1}^{500} ( {log}_{10} ( {S}_{j , k} ) - {log}_{10} ( {S}_{true , k} ) ) \vert}{500 \times 60} , \qquad ( 15 )$$

wherein S_{j,k} is the estimated speed at the k^{th} print size in the j^{th} run, and S_{true,k} is the true reading speed at the k^{th} print size.

The bias of the estimated parameters α, κ, η and the AAB of the estimated reading speeds according to the techniques described herein are plotted as functions of trial number in FIGS. 6(a), 6(b), 6(c) and 6(d), respectively. The bias of the estimated α, κ, η and the AAB of the estimated speeds were −0.064, 0.030, 0.100 and 0.099 log10 units after 50 trials, respectively, and decreased to −0.008, 0.010, 0.029 and 0.022 log10 units after 150 trials, respectively. As illustrated by FIG. 6(d), the techniques described herein can efficiently provide precise and accurate assessment of the reading speed versus print size function. Accordingly, the computer simulations illustrated that both the inter-run standard deviation and intra-run 68.2% HWCI of the estimated reading speed based on the techniques described herein were less than 0.1 log10 units with only 150 trials, with a bias of 0.05 log10 units.

To further validate the performance of the systems and methods described herein, the techniques described herein and a Psi method were applied to four human observes to provide a measure of the reading speed versus print size function according to a word/non-word lexical decision task. The Psi method was used to provide an independent measure of reading speed at each of a range of print sizes one at a time. The results obtained from the Psi method were used to (1) test whether the reading speed versus print size functions estimated according to the techniques described herein, which assesses the parameters of the entire function in each trial, is equivalent to those obtained in a series of print sizes, (2) compare the two methods in terms of relative efficiency, and (3) test some of the underlying assumptions of the techniques described herein. The settings of the systems and methods described herein used in the experiment were about the same as those used in the simulation discussed above except that the range and sampling of print sizes and presentation durations were adjusted to accommodate the physical limits (e.g., pixel size and refresh interval) of a visual stimulation system (e.g., a monitor). The range of possible stimuli was about 50 print sizes from 4.34 to 89.7 arcmin.

The stimuli used in the validation were five-letter strings. The letter strings were presented in black on a gray background (33 cd/m²) in the Arial font style on the display. 50 print sizes (evenly sampled in log space from 4.34 to 89.7 arcmin) and 33 exposure durations (evenly sampled in log space from 0.013 to 1 second) were used during the validation. The sizes and durations were rounded to the nearest physically available values in the unit of pixels and refresh intervals, separately. The Psi method was applied to measure threshold reading speeds at six print sizes that were selected for each individual based on data collected in a practice session. Each individual was given a practice session of 225 trials using the techniques described herein. Data from the practice session was used to determine the six print sizes to provide adequate sampling of the reading speed versus print size function in the subsequent Psi method test for each individual.

During the validation, MCWord was used to create five-letters word and non-word stimuli that were generated from a CELEX English database and were based on the frequencies of written and spoken text from almost 18 million instances of word use. The most frequent 500 real five-letter words from the database were used as word stimuli, and 500 non-word stimuli was generated with constrained trigram statistics that match three letter combinations in the database. During each reading test administration, a five-letter string was randomly selected from the pre-generated word/non-word pool. The string could be either a word or a non-word with equal probability. The individuals had to decide whether the string is a word or non-word.

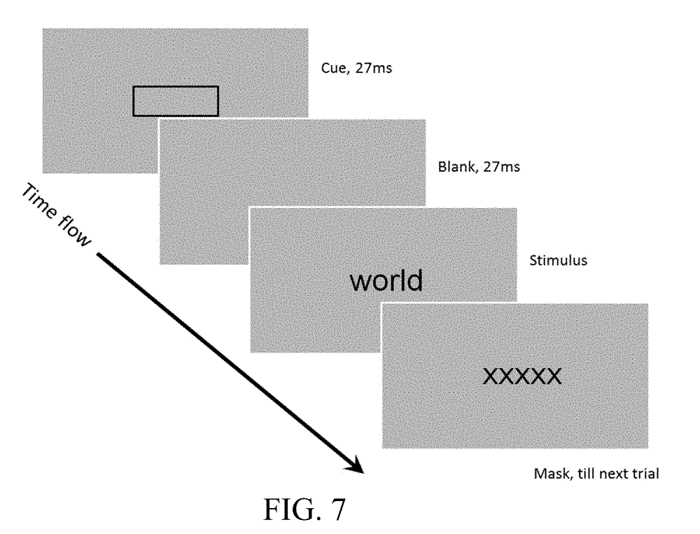

The display sequence of one trial is illustrated in FIG. 7. Each trial began with a 27-ms presentation of a rectangle box in the center of the display. The size of the box was the same as that of the outline of the to-be-presented letter string. This was followed by a 27 ms blank screen, a five-letter string with a certain print size and exposure duration, and a mask made of “xxxxx” of the same size that was present until the next trial started. For select trials, the print size and exposure duration of the stimulus were determined based on the systems and methods described herein. For other trials, the print size was randomly selected from the pre-determined sizes and the exposure duration based on the Psi method. Individuals were instructed to use the two buttons on the mouse to indicate if the letter string was a word or non-word. A new trial started 500 millisecond (ms) after the response.

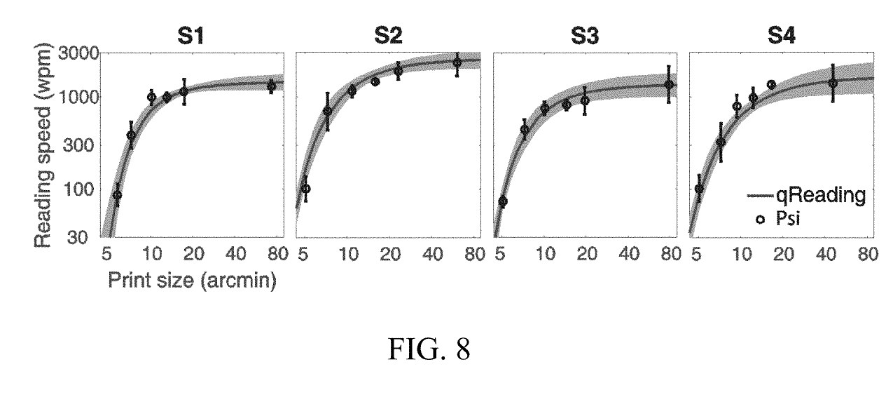

FIG. 8 represents the reading speed versus print size functions of four individuals, obtained based on the techniques described herein and the Psi method. In FIG. 8 shaded area and error bars represent±1SD. The estimated reading speed versus print size functions obtained by the techniques described herein is shown as solid curves, and those obtained by the Psi method is shown as circles. The standard deviation of the estimated reading speeds based on the techniques described herein were calculated based on eight repeated runs. The standard deviation of the Psi estimates was computed from four repeated runs.

The parameters estimated by the techniques described herein and the Psi method were compared to provide an evaluation of performance of the reading measurements techniques described herein. Equation 1 was fitted to the six reading speeds versus print size curve estimated by the Psi method in each session for each individual. The estimated reading parameters, α, κ, η from the Psi method, were determined by the best fitted parameter values, averaged across sessions and plotted against the average parameters measured directly based on the techniques described herein in FIGS. 6(a)-6(c). The Pearson correlation coefficients between the estimated parameters from the two techniques were 0.948 (p=0.052), 0.997 (p=0.003) and 0.975 (p=0.025) for α, κ, η, respectively. No significant difference was found between the estimated α(t(3)=2.76, p=0.067) and a (t(3)=1.97, p=0.144) based on the two techniques. The estimated η provided by the techniques described herein was significantly smaller than that from the Psi method (t(3)=4.37, p=0.022).

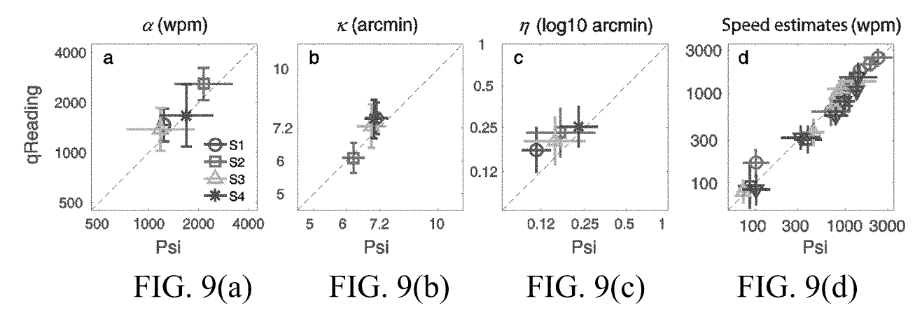

FIGS. 9(a)-9(d) illustrates estimated parameters of the reading speed versus print size function α, κ, η as well as the estimated reading speeds according to the techniques described herein and the Psi method. Four different symbols are utilized in FIGS. 9(a)-9(d) to represent data from the four individuals. In FIG. 9(d), estimated reading speeds at the six print sizes used in the Psi method from both the techniques described herein and Psi method are plotted against each other. Data generated based on the techniques described herein and the Psi method showed excellent agreement.

Because an exponential reading speed versus print size function with three parameters was used (Eq. 1), the reading speeds obtained from the techniques described herein are not independent across print size conditions. To compute the correlation of the reading speeds estimated by the two methods, for each individual the dependency across print size conditions needs to be eliminated. Because an exponential reading function with three parameters was used (Eq. 1), the reading speeds obtained from the techniques described herein are not independent across print size conditions. To compute the correlation of the reading speeds estimated by the techniques described herein and the Psi method, the following procedure for each individual was carried out to eliminate the dependency across conditions: (1) the reading speeds in the six print size conditions were first derived from the reading curves obtained with the techniques described herein; (2) for each of the six print sizes, randomly select one run according to the techniques described herein (out of eight, without replacement) and obtain the reading speed at that print size; (3) compute the correlation coefficient between the reading speeds in step (2) with those obtained by the Psi method; and (4) repeat steps (2) to (3) five hundred times and calculate the average correlation coefficient. In this procedure, the reading speeds at different sizes were from entirely different runs and were not constrained by the exponential model. Across all individuals, the average correlation coefficient between the estimated reading speeds obtained with the two methods was 0.969±0.005 (p<0.01 for all individuals). A repeated measure ANOVA with print size and method as factors was applied on estimated reading speeds obtained from the two methods. The method had no significant effect (F(1, 15)=0.036, p=0.862).

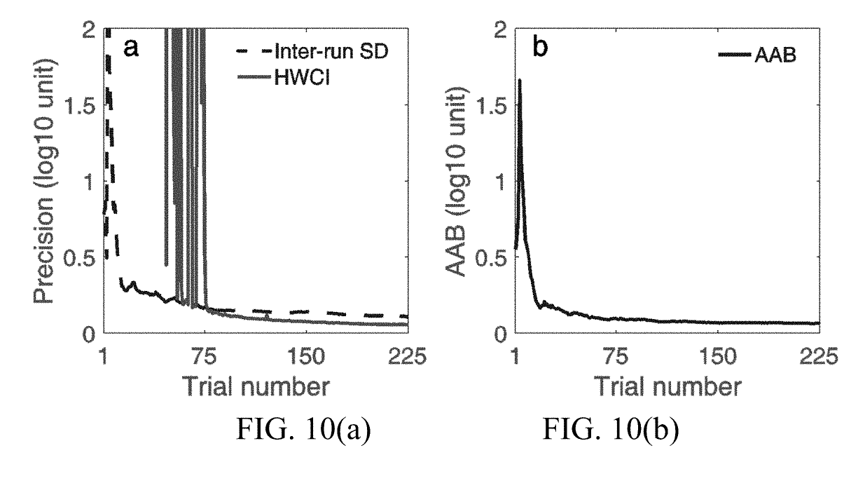

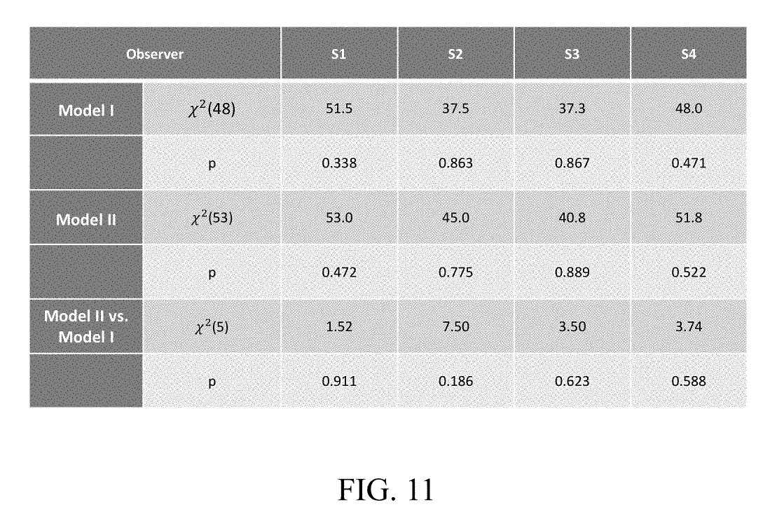

The average inter-run standard deviation and intra-run 68.2% HWCI of the estimated reading speed across print sizes and individuals from the eight runs based on the techniques described herein can be computed. FIG. 10(a) illustrates the inter-run standard deviation and intra-run HWCI of the estimated reading speed based on the techniques described herein as functions of trial number. FIG. 10(b) illustrates the AAB of the estimated reading speed based on the techniques described herein as a function of trial number. The average inter-run standard deviation of the estimated reading speed based on the techniques described herein was 0.172±0.077, 0.141±0.048, and 0.109±0.044 log 10 units after 75, 150 and 225 trials, respectively. The average 68.2% HWCI of the estimated reading speed based on the techniques described herein was 0.570±4.00, 0.078±0.077, and 0.058±0.040 log10 units after 75, 150 and 225 trials, respectively. For comparison, the average inter-run standard deviation and HWCI of the estimated reading speed measured by the Psi method was 0.112±0.055 and 0.067±0.08 log10 units with 450 trials. The standard deviation and 68.2% HWCI of the estimated reading speeds based on the techniques described herein decreased rapidly in the beginning of the procedure. After about 80 trials, the HWCI was almost the same as the inter-run standard deviation.

Using the mean reading speeds from the four Psi runs as the “truth”, we computed the average absolute bias of the estimated reading speed obtained based on the techniques described herein using the following equation:

$$A A B = \frac{{\sum }_{k = 1}^{50} \vert {\sum }_{j = 1}^{8} ( {log}_{10} ( {S}_{j , k} ) - {log}_{10} ( {S}_{true , k} ) ) \vert}{50 \times 8} . \qquad ( 16 )$$

The average absolute bias of the estimated reading speed obtained based on the techniques described herein across print sizes and individuals is plotted as a function of trial number in FIG. 7(b). The AAB was 0.098±0.026, 0.069±0.027 and 0.065±0.012, log10 units after 75, 150, and 225 trials, respectively. Given that the “true” reading speeds estimated by the Psi method had an average standard deviation of 0.11 log10 units, an average absolute bias of 0.065 log10 units is relatively small.

In order to examine the test-retest reliability of the techniques described herein, the overall concordance correlation coefficient (OCCC) for assessing agreement among eight measurements according to the techniques described herein was analyzed. The OCCC is the weighted average of the pair-wise concordance correlation coefficient between any two reading measurements according to the techniques described herein, which measures the agreement between two tests by measuring the variation from the 45 degree line (diagonal) through the origin. The mean OCCC of the estimated reading speed across four individuals was 0.891±0.024.

An underlying assumption of the techniques described herein is that, the slope β of the psychometric function for the word/non-word lexical decision task is the same at different print sizes and can be fixed at 2.0 (Eq. 9). It is important to know if the fixed slope assumption is valid in the real human experiment and if the true slope differs from the assumed value of 2.0. As such, for each individual, data from the Psi method in all four sessions were pooled together. There were 300 trials in each print size condition, which were binned by dividing the log exposure duration into 10 equally spaced intervals. The percent of correct responses in the 10 bins allowed us to construct a raw psychometric function in each print size condition. Then two models (I and II) were constructed and both models were fitted to the raw psychometric function using a maximum likelihood procedure. Model I, in which the psychometric functions of the word/non-word lexical decision task have different thresholds and slopes in different print size conditions, fit the raw psychometric functions well for all individuals (x²test, all p>0.05, Table 1). Model II, in which the thresholds are different but the slope is the same in different print size conditions, also provided good fits to the data for all individuals (x2 test, all p>0.05, Table 1). A nested model test showed that Model II is statistically equivalent to Model I (x² test, all p<0.05, Table 1), indicating that the fix slope assumption in the techniques described herein held true in our experimental data. From the best fitting Model II of each individual, the averaged slope across individuals was computed. It was 2.06±0.381, not significantly different from the assumed value in the techniques described herein (t(3)=0.312, p=0.776).

Accordingly, the estimated parameter of the reading function as well as reading speeds based on the techniques described herein were highly correlated with those from the Psi method. The inter-run standard deviation, intra-run HWCI and average absolute bias of the estimated reading speeds based on the techniques described herein were 0.109±0.045, 0.058±0.040 and 0.065±0.012 log 10 units after 225 trials, respectively. Moreover, to achieve the same amount of precision, the techniques described herein can only require about half the number of trials as the Psi method. The test-retest reliability, as indicated by the OCCC of the reading speed measured based on the techniques described herein was 0.891±0.024.

What have been described above are examples. It is, of course, not possible to describe every conceivable combination of components or methods, but one of ordinary skill in the art will recognize that many further combinations and permutations are possible. Accordingly, the disclosure is intended to embrace all such alterations, modifications, and variations that fall within the scope of this application, including the appended claims. Additionally, where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, and the term “including” means including but not limited to. The term “based on” means based at least in part on. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A computer implemented method comprising:
generating a reading performance model comprising a set of reading parameters based on baseline reading performance data and/or baseline oculomotor control data, wherein the reading performance model provides an estimated reading performance for an individual;
determining one or more stimulus parameters for a reading test based on the set of reading parameters, wherein the test is administered to the individual to assess the reading performance for the individual;
controlling an administration of the reading test to the individual based on the one or more stimulus parameters;
receiving reading performance data characterizing one or more responses made by the individual in the reading test, and eye movement data characterizing eye movements made by the individual during the reading test;
updating the set of reading parameters of the reading performance model based on the reading performance data and the eye movement data to update the estimated reading performance for the individual; and
repeating the generating, the controlling, the receiving and the updating according to a criterion to refine the estimated reading performance for the individual for a plurality of subsequent administrations of the reading test.

2. The computer implemented method of claim 1, wherein the reading performance model is one of a parametric behavior model, a non-parametric behavior model, and a combination thereof.

3. The computer implemented method of claim 2, further comprising generating a prior joint probability density function for all reading parameters of the reading performance model.

4. The computer implemented method of claim 3, wherein the probability density function is one of an uninformative prior corresponding to a uniform distribution, a weakly informative prior, and an informative prior.

5. The computer implemented method of claim 4, further comprising:
updating the prior probability density function of at least one of the reading parameters of the reading performance model according to a Bayes' rule based on the reading performance data to generate a posterior probability density function for the reading parameters of the reading performance model, wherein the Bayes' rule corresponds to:
$${p}_{t} ( θ ) = {p}_{t} ( θ \vert {r}_{x} ) = \frac{{p}_{t - 1} ( θ ) p ( {r}_{x} \vert θ )}{{\sum }_{θ} {p}_{t - 1} ( θ ) p ( {r}_{x} \vert θ )}$$
wherein θ represents the set of reading parameters of the reading performance model, pₜ₋₁(θ) is the prior probability density function of θ of a previous administration of the reading test, p(rₓ|θ) is a likelihood of observing a response given θ and a given stimulus parameter, rₓ is the one or more responses of the individual in each subsequent administration of the reading test according to the given stimulus parameter, and pₜ(θ|rₓ) is the posterior distribution of θ after each subsequent administration of the reading test to the individual.

6. The computer implemented method of claim 5, further comprising:
determining a given subsequent stimulus parameter to control a given subsequent administration of the reading test to the individual based on the updated probability density function for the reading parameters of the reading performance model associated with a previous administration of the reading test to the individual; and
updating the prior probability density function for at least one of the reading parameters of the reading performance model for each subsequent administration of the reading test to the individual based on the determined given subsequent stimulus parameter.

7. The computer implemented method of claim 6, wherein updating the prior probability density function for at least one of the reading parameters of the reading performance model for each subsequent administration of the reading test to the individual based on the determined given subsequent stimulus parameter comprises:
controlling each subsequent administration of the reading test to the individual based on the given subsequent stimulus parameter; and
receiving, during each subsequent administration of the reading test, corresponding reading performance data associated with the individual.

8. The computer implemented method of claim 7, further comprising:
updating the prior probability density function for at least one of the reading parameters of the reading performance model based on corresponding reading performance data associated with the given administration of the reading test to generate the posterior probability density function for the reading parameters of the reading performance model; and
determining the given subsequent stimulus parameter for the subsequent administration of the reading test to the individual test based on the posterior probability density function for the reading parameters of the reading performance model associated with the prior administration of the reading test to the individual.

9. The computer implemented method of claim 8, wherein determining the given subsequent stimulus parameter comprises selecting the given subsequent stimulus parameter from a plurality of stimulus parameters that optimize an expected information gain on the set of reading parameters of the reading performance model, wherein the one plurality of stimulus parameters comprise the one or more stimulus parameters.

10. The computer implemented method of claim 9, wherein the selecting of the given subsequent stimulus parameter is based on the joint posterior probability density function of all reading parameters of the reading performance model and based on expected responses to all possible subsequent administrations of the reading test.

11. The computer implemented method of claim 10, wherein the method further comprises determining the stimulus parameters for the subsequent administration of the reading test that maximizes the expected information gain on the reading performance model.

12. The computer implemented method of claim 11,
wherein the reading performance model corresponds to a reading function; and
wherein the reading function provides an estimate of the individual's reading speed and/or oculomotor behavioral over a range of letter sizes corresponding to the estimated reading performance.

13. A system comprising:
a non-transitory memory to store machine readable instructions and data;
a processor to access the memory and execute the machine readable instructions, the machine readable instructions causing the processor to:
define a reading performance model comprising a set of reading parameters based on baseline reading performance data and baseline oculomotor control data, wherein the reading performance model provides an estimated reading performance for an individual;
determine a stimulus parameter for a reading test based on the set of reading parameters, wherein the test is administered to the individual to assess the reading performance for the individual;
control an administration of the reading test to the individual based on the stimulus parameter;
receive reading performance data characterizing one or more responses of the individual based on the reading test, and eye movement data characterizing eye movements made by the individual during the reading test; and
update the set of reading parameters of the reading performance model based on the reading performance data and the eye movement data to update the estimated reading performance for the individual.

14. The system of claim 17, further comprising:
a stimulation system to administer the reading test to the individual according to the stimulus parameter, wherein the processor controls the stimulation system to control the administration of the reading test to the individual and to capture the eye movement data generated by an eye tracking system; and
a data exchange interface to send or receive data, wherein the data exchange interface corresponds to one of a graphic user interface for tester to input data or parameters, a USB port, and a serial port or network interface to transfer the data.

15. The system of claim 14, wherein the machine readable instructions further cause the processor to repeat the determining, the controlling, the receiving and the updating according to a criterion to refine the estimated reading performance for the individual for a plurality of subsequent administrations of the reading test.

16. The system of claim 15, wherein the machine readable instructions further cause the processor to generate a prior probability density function for each reading parameter of the reading performance model.

17. The system of claim 16, wherein the machine readable instructions further cause the processor to:
update the prior probability density function for at least one of the reading parameters of the reading performance model according to a Bayes' rule based on the reading performance data to generate a posterior probability density function for the reading parameters of the reading performance model, wherein the Bayes' rule corresponds to:
$${p}_{t} ( θ ) = {p}_{t} ( θ \vert {r}_{x} ) = \frac{{p}_{t - 1} ( θ ) p ( {r}_{x} \vert θ )}{{\sum }_{θ} {p}_{t - 1} ( θ ) p ( {r}_{x} \vert θ )}$$
wherein θ represents the set of reading parameters of the reading performance model, pₜ₋₁(θ) is the prior probability density function of θ of a previous administration of the reading test, p(rₓ|θ) is a likelihood of observing a response given θ and a given stimulus parameter, rₓ is the one or more responses of the individual in each subsequent administration of the reading test according to the given stimulus parameter, and pₜ(θ|rₓ) is the posterior distribution of θ after each subsequent administration of the reading test to the individual.

18. The system of claim 17, wherein the machine readable instructions further cause the processor to:
determine the stimulus parameters to control a given subsequent administration of the reading test to the individual based on the updated probability density function of the reading parameters of the reading performance model associated with a previous administration of the reading test to the individual; and
iteratively update the probability density function for at least one of the reading parameters of the reading performance model by controlling each subsequent administration of the reading test to individual based on the stimulus parameters and receiving, during each subsequent administration of the reading test, corresponding reading performance data associated with the individual.

19. The system of claim 18, wherein iteratively updating the probability density function for the reading parameters of the reading performance model comprises:
refining the prior probability density function for at least one of the reading parameters of the reading performance model based on the corresponding reading performance data of the subsequent administration of the reading test to generate the posterior probability for the reading parameters of the reading performance model and oculomotor control estimates; and
determining the stimulus parameters for the subsequent administration of the reading test to the individual based on the posterior probability density function for the reading parameters of the reading performance model associated with the prior administration of the reading test to the individual.

20. The system of claim 19,
wherein the reading performance model corresponds to a reading function; and
wherein the reading function provides an estimate of the individual's reading speed and oculomotor behavior over a range of letter sizes corresponding to the estimated reading performance.

21. A computer implemented method comprising:
defining a reading performance model comprising a set of reading parameters based on baseline reading performance data and baseline oculomotor control data, wherein the reading performance model provides an estimated reading performance for an individual;
receiving reading performance data characterizing one or more responses of the individual based on a plurality of administered reading test to the individual, and eye movement data characterizing eye movements made by the individual during each administered reading test; and
updating the set of reading parameters of the reading performance model based on the reading performance data and the eye movement data to update the estimated reading performance for the individual.

22. The computer implemented method of claim 21, further comprising generating a prior probability density function for each reading parameter of the reading performance model, wherein the probability density function is one of an uninformative prior corresponding to a uniform distribution, a weakly informative prior, and an informative prior.

23. The computer implemented method of claim 4, further comprising:
updating the prior probability density function for at least one of the reading parameters of the reading performance model according to a Bayes' rule based on the reading performance data to generate a posterior probability density function for the reading parameters of the reading performance model, wherein the Bayes' rule corresponds to:
$${p}_{t} ( θ ) = {p}_{t} ( θ \vert {r}_{x} ) = \frac{{p}_{t - 1} ( θ ) p ( {r}_{x} \vert θ )}{{\sum }_{θ} {p}_{t - 1} ( θ ) p ( {r}_{x} \vert θ )}$$
wherein θ represents the set of reading parameters of the reading performance model, pₜ₋₁(θ) is the prior probability density function of θ of an administered reading test, p(rₓ|θ) is a likelihood of observing a response given θ and a given stimulus parameter, rₓ is the one or more responses of the individual in each subsequent administered reading test according to the given stimulus parameter, and pₜ(θ|rₓ) is the posterior distribution of θ after each subsequent administered reading test to the individual.

24. The computer implemented method of claim 23, further comprising updating the prior probability density function for at least one of the reading parameters of the reading performance model for each subsequent administered reading test to the individual.

25. The computer implemented method of claim 24, further comprising updating the prior probability density function for at least one of the reading parameters of the reading performance model based on corresponding reading performance data associated with the given administration of the reading test to generate the posterior probability density function for the reading parameters of the reading performance model.
